(19) United States
(12) Patent Application Publication
(10) Pub. No.: US 2025/0375931 A1
(43) Pub. Date: Dec. 11, 2025

(54) HEAT-SHRINKABLE FILM

(71) Applicant: GUNZE LIMITED, Kyoto (JP)

(72) Inventors: Ibuki SHIMAZAKI, Shiga (JP); Jun TAKAICHI, Shiga (JP); Kensuke KAMEI, Shiga (JP); Nobuhiro WATANABE, Shiga (JP)

(73) Assignee: GUNZE LIMITED, Kyoto (JP)

(21) Appl. No.: 19/100,371

(22) PCT Filed: Aug. 1, 2023
(86) PCT No.: PCT/JP2023/028088

§ 371 Date: Jan. 31, 2025

(30) Foreign Application Priority Data
Aug. 3, 2022 (JP) 2022-124018

(51) Int. Cl. B29C 48/08; B29C 48/00; B29C 48/21; B29K 23/00; B29K 96/00; B29K 105/00; B29K 433/04; B29L 31/00

(52) U.S. Cl. CPC B29C 48/08; B29C 48/022; B29C 48/21; B29K 2023/08; B29K 2023/12; B29K 2023/38; B29K 2096/00; B29K 2105/251; B29K 2433/12; B29K 2995/0012; B29K 2995/0018; B29K 2995/0049; B29K 2995/0063; B29K 2995/0097; B29L 2031/744

(57) ABSTRACT

A heat-shrinkable film includes a first layer containing at least one of a petroleum resin, a terpene-based resin, or a rosin-based resin and containing a propylene-based resin, a cyclic olefin-based resin, and an ethylene-based resin containing an ethylene component in an amount of 50 mol % or more and having a melting point of 70° C. or higher.

### TECHNICAL FIELD

The present disclosure relates to a heat-shrinkable film.

### BACKGROUND ART

Patent Literature 1 discloses a heat-shrinkable polyolefin-based film exhibiting favorable heat resistance, having a high horizontal heat shrinkage rate, and suitably used as a base material of a label to be attached to a bottle having a complicated shape. According to Patent Literature 1, this heat-shrinkable polyolefin-based film includes at least a core layer and surface layers stacked on both sides of the core layer. The core layer contains an ethylene-propylene random copolymer having a Tm of 140° C. in an amount of 54% by weight, an ethylene-butylene random copolymer having a Tm of 66° C. in an amount of 8% by weight, an ethylene-norbornene random copolymer having a Tg of 78° C. and a norbornene content of 65% by weight in an amount of 20% by weight, and a hydrogenated petroleum resin having a softening point of 140° C. in an amount of 18% by weight.

### CITATION LIST

### Patent Literature

Patent Literature 1: JP 2015-509861 A

### SUMMARY OF THE INVENTION

### Technical Problems

However, the heat-shrinkable polyolefin-based film of Patent Literature 1 has a (horizontal) heat shrinkage rate of about 40% to 43% when this film is immersed in hot water at 90° C. for 10 seconds, which is a low level for actual use. Moreover, for this heat-shrinkable film, it is necessary to enhance heat shrinkage at a high temperature while suppressing a natural shrinkage rate low under general environment not intended for heat shrinkage. Patent Literature 1 fails to take this point into consideration.

It is an object of the present invention to provide a heat-shrinkable film for which a natural shrinkage rate is suppressed while a heat shrinkage rate at a high temperature is improved.

### SOLUTIONS TO THE PROBLEMS

A heat-shrinkable film according to a first aspect includes a first layer containing at least one of a petroleum resin, a terpene-based resin, or a rosin-based resin and containing a propylene-based resin, a cyclic olefin-based resin, and an ethylene-based resin containing an ethylene component in an amount of 50 mol % or more and having a melting point of 70° C. or higher.

A heat-shrinkable film according to a second aspect is the heat-shrinkable film according to the first aspect, in which the first layer further contains a microparticle, and in the first layer, a closed pore is formed so as to surround the microparticle.

A heat-shrinkable film according to a third aspect is the heat-shrinkable film according to the first or second aspect, which further includes a second layer stacked on at least one side of the first layer and containing a thermoplastic resin.

A heat-shrinkable film according to a fourth aspect is the heat-shrinkable film according to any one of the first to third aspects, in which when the total of a thermoplastic resin contained in the first layer is 100% by weight, the first layer contains the propylene-based resin in an amount of 10% by weight or more and 75% by weight or less, and the propylene-based resin has a Vicat softening temperature of 90° C. or higher.

A heat-shrinkable film according to a fifth aspect is the heat-shrinkable film according to any one of the first to fourth aspects, in which when the total of the thermoplastic resin contained in the first layer is 100% by weight, the first layer contains the propylene-based resin in an amount of 10% by weight or more and 50% by weight or less.

A heat-shrinkable film according to a sixth aspect is the heat-shrinkable film according to any one of the first to fifth aspects, in which when the total of the thermoplastic resin contained in the first layer is 100% by weight, the first layer contains the ethylene-based resin in an amount of 0.1% by weight or more and 65% by weight or less.

A heat-shrinkable film according to a seventh aspect is the heat-shrinkable film according to any one of the first to sixth aspects, in which the ethylene-based resin has a density of 0.88 g/cm³ or more and 0.95 g/cm³ or less.

A heat-shrinkable film according to an eighth aspect is the heat-shrinkable film according to any one of the first to seventh aspects, in which the ethylene-based resin has a melting point of 75° C. or higher.

A heat-shrinkable film according to a ninth aspect is the heat-shrinkable film according to any one of the first to eighth aspects, in which when the total of the thermoplastic resin contained in the first layer is 100% by weight, the first layer contains the cyclic olefin-based resin in an amount of 0.1% by weight or more and 85% by weight or less, and has a glass transition temperature of 20° C. or higher and 130° C. or lower.

A heat-shrinkable film according to a tenth aspect is the heat-shrinkable film according to any one of the first to ninth aspects, in which when the total of the thermoplastic resin contained in the first layer is 100 parts by weight, the first layer contains the microparticles in an amount of 0.005 parts by weight or more and 1 part by weight or less.

A heat-shrinkable film according to an eleventh aspect is the heat-shrinkable film according to any one of the first to tenth aspects, in which the microparticles have a most frequent particle size of 1 μm or more and 8 μm or less.

A heat-shrinkable film according to a twelfth aspect is the heat-shrinkable film according to any one of the first to eleventh aspects, in which the heat-shrinkable film has a density of 0.95 g/cm³ or less.

A heat-shrinkable film according to a thirteenth aspect is the heat-shrinkable film according to any one of the first to twelfth aspects, in which the heat-shrinkable film has a haze of 10% or less.

A heat-shrinkable film according to a fourteenth aspect is the heat-shrinkable film according to any one of the first to thirteenth aspects, in which the second layer contains at least one of a petroleum resin, a terpene-based resin, or a rosin-based resin and containing a cyclic olefin-based resin, an ethylene-based resin, and a microparticle.

A heat-shrinkable film according to a fifteenth aspect is the heat-shrinkable film according to any one of the first to fourteenth aspects, in which when the thickness of the second layer is 1, the first layer has a thickness of 4 or more and 8 or less.

A heat-shrinkable label according to a sixteenth aspect includes the heat-shrinkable film according to any one of the first to fifteenth aspects.

### Advantageous Effects of the Invention

According to the present invention, the heat-shrinkable film is provided, for which the natural shrinkage rate is suppressed while the heat shrinkage rate at the high temperature is improved.

### BRIEF DESCRIPTION OF THE DRAWINGS

FIG. 1 is a sectional view showing one example of a heat-shrinkable film of the present invention.

FIG. 2 is a sectional view showing one example of the heat-shrinkable film of the present invention.

FIG. 3A is a microphotograph of the section of a layer containing microparticles.

FIG. 3B is a microphotograph of the section of a layer containing no microparticles.

### DESCRIPTION OF EMBODIMENTS

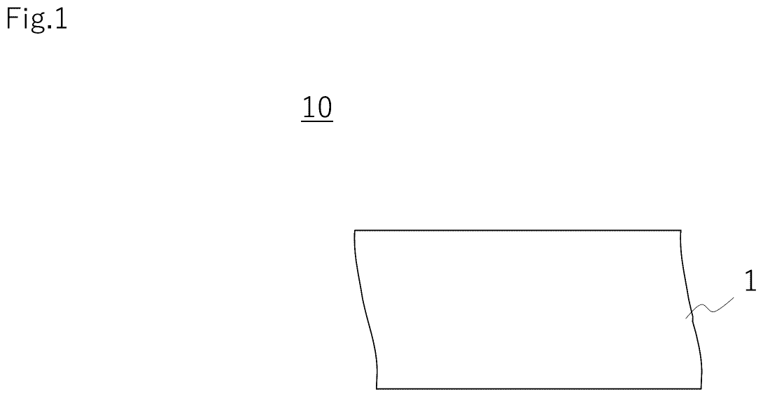

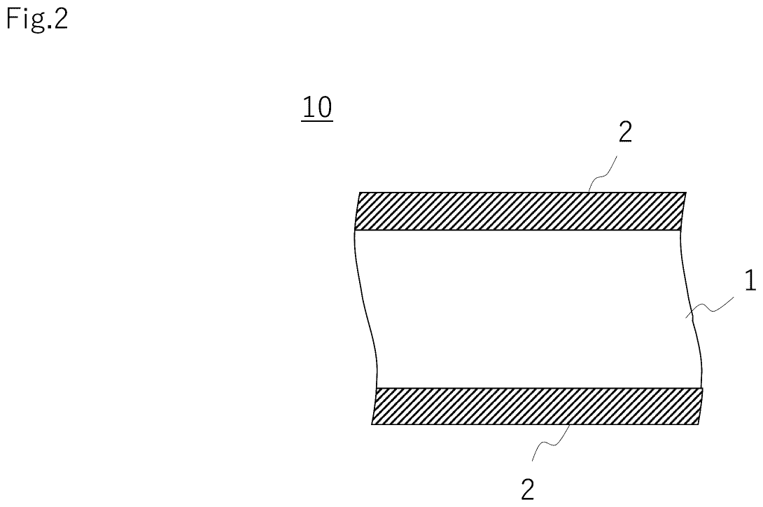

Hereinafter, one embodiment of a heat-shrinkable film 10 according to the present invention will be described. As shown in FIG. 1, the heat-shrinkable film 10 includes at least a sheet-shaped core layer 1 (first layer) having a first surface and a second surface. As shown in FIG. 2, the heat-shrinkable film 10 may further include a surface layer 2 (second layer) stacked on at least one of the first or second surface of the core layer 1. That is, the heat-shrinkable film 10 may have a single-layer configuration including only the core layer 1, a double-layer configuration further including the surface layer 2 stacked on one side of the core layer 1, or a triple-layer configuration including the surface layers 2 stacked on both sides of the core layer 1.

Note that the figures do not necessarily reflect actual dimensions. Hereinafter, each member will be described in detail.

### 1-1. First Example of Core Layer

The core layer 1 contains a thermoplastic resin as a main component. The core layer 1 contains at least a propylene-based resin; at least one of a petroleum resin, a terpene-based resin, or a rosin-based resin; a cyclic olefin-based resin; and an ethylene-based resin. In addition, the core layer 1 may further contain microparticles. Hereinafter, the configuration of a core layer 1 according to a first example will be described.

### [Propylene-Based Resin]

The propylene-based resin is a resin containing a propylene component in an amount of 50 mol % or more. The propylene-based resin enhances the elastic modulus and tensile strength of the heat-shrinkable film 10. From the viewpoint of exhibiting heat-shrinkable properties, as the propylene-based resin, a propylene-based binary copolymer or a propylene-based ternary copolymer containing propylene as a main component and α-olefin as a copolymerization component is preferable, and a propylene-based ternary random copolymer is particularly preferable. Examples of the α-olefin include ethylene, 1-butene, 1-pentene, 1-hexene, 4-methyl-1-pentene, 1-octene, and the like. The ratio of the α-olefin as the copolymerization component is preferably 1 to 10 mol %. The propylene-based resin may be a mixture of different propylene-α-olefin random copolymers. The propylene-based resin may contain long-chain branching polypropylene and a propylene-based elastomer.

The propylene-based resin has a Vicat softening temperature of preferably 90° C. or higher, more preferably 100° C. or higher, and much more preferably 110° C. or higher. In a case where the propylene-based resin is a resin mixture containing two or more types of propylene-based resins having different Vicat softening temperatures, the Vicat softening temperature of the propylene-based resin means an apparent Vicat softening temperature calculated by summing the products of the Vicat softening temperatures and blending proportions (ratios by weight) of the respective propylene-based resins.

The propylene-based resin has a melt flow rate (MFR) at 230° C. of preferably 1.0 g/10 min or more and 10.0 g/10 min or less, more preferably 3.0 g/10 min or more and 8.0 g/10 min or less, and much more preferably 4.0 g/10 min or more and 7.0 g/10 min or less.

The propylene-based resin has a density of preferably 0.89 g/cm³ or more and 0.93 g/cm³ or less.

When the total of the thermoplastic resin contained in the core layer 1 is 100% by weight, the core layer 1 contains the propylene-based resin in an amount of preferably 10% by weight or more and 75% by weight or less, more preferably 10% by weight or more and 50% by weight or less, much more preferably 15% by weight or more and 45% by weight or less, and particularly preferably 20% by weight or more and 40% by weight or less.

### [Petroleum Resin]

The petroleum resin improves the heat-shrinkable properties of the heat-shrinkable film 10. The petroleum resin is a resin obtained by polymerizing remaining C4 to C5 fractions (mainly a C5 fraction) or C5 to C9 fractions (mainly a C9 fraction) after removal of ethylene, propylene, butadiene, and the like by thermal decomposition of naphtha or a mixture thereof, and for example, includes an alicyclic petroleum resin from cyclopentadiene or a dimer thereof, an aromatic petroleum resin from a C9 component, and the like. From the viewpoint of suppressing softening of the heat-shrinkable film at 100° C. or lower and ensuring transparency and rigidity, a hydrogenated alicyclic petroleum resin having a partially or completely hydrogenated alicyclic structure is preferable. It is also possible to use a resin obtained by purifying and polymerizing one or more components in a C5 fraction or a C9 fraction.

Examples of commercially available products of the petroleum resin described above include I-MARV (manufactured by Idemitsu Kosan Co., Ltd.), ARKON (manufactured by Arakawa Chemical Industries, Ltd.), Regalite (manufactured by Eastman Chemical Company), and the like.

The petroleum resin has a softening point of preferably 100° C. or higher and 150° C. or lower, more preferably 110° C. or higher and 140° C. or lower, and much more preferably 120° C. or higher or 130° C. or lower. When the softening point of the petroleum resin falls within the above-described range, favorable heat-shrinkable properties can be exhibited. In a case where the petroleum resin is a resin mixture containing two or more types of petroleum resins having different softening points, the softening point means an apparent softening point calculated by summing the products of the softening points and blending proportions (ratios by weight) of the respective petroleum resins.

When the total of the thermoplastic resin contained in the core layer 1 is 100% by weight, the core layer 1 contains the petroleum resin in an amount of preferably 10% by weight or more and 40% by weight or less, more preferably 15% by weight or more and 35% by weight or less, and much more preferably 20% by weight or more and 30% by weight or less. When the content of the petroleum resin falls within this range, a decrease in elongation under a low temperature and peeling between the layers can be suppressed. In a case where the core layer 1 contains the terpene-based resin to be described later and the like, the above-described range is applicable to the entirety of a hydrocarbon resin containing the petroleum resin, the terpene-based resin, and the rosin-based resin.

### [Terpene-Based Resin and the Like]

The core layer 1 may further contain a hydrocarbon resin other than the petroleum resin, such as the terpene-based resin and the rosin-based resin, in addition to or instead of the petroleum resin. Examples of the terpene-based resin include a terpene resin from α-pinene or β-pinene, a copolymer of α-pinene, β-pinene, and the like, an aromatic modified terpene resin, a terpene-phenolic resin, and a hydrogenated terpene resin. Examples of the rosin-based resin include gum rosin, wood rosin, tall oil rosin, esterified rosin denatured by glycerin, pentaerythritol, or the like, and a hydrogenated rosin-based resin.

### [Cyclic Olefin-Based Resin]

The cyclic olefin-based resin improves both the heat-shrinkable properties and rigidity of the heat-shrinkable film 10. The cyclic olefin-based resin is an amorphous resin, and therefore, can lower the crystallinity of the heat-shrinkable film and also enhance stretchability upon production. The cyclic olefin-based resin is, for example, (a) a random copolymer of ethylene or propylene and cyclic olefin, (b) a ring-opened polymer of the cyclic olefin or a copolymer with α-olefin, (c) a hydrogenated product of the polymer of (b), (d) a graft-modified product of (a) to (c) with an unsaturated carboxylic acid and a derivative thereof, or the like.

Examples of the cyclic olefin include, but not particularly limited to, norbornene and a derivative thereof, such as norbornene, 6-methylnorbornene, 6-ethylnorbornene, 5-propylnorbornene, 6-n-butylnorbornene, 1-methylnorbornene, 7-methylnorbornene, 5,6-dimethylnorbornene, 5-phenylnorbornene, and 5-benzylnorbornene. Further, the examples include tetracyclododecene and a derivative thereof, such as tetracyclododecene, 8-methyltetracyclo-3-dodecene, 8-ethyltetracyclo-3-dodecene, and 5,10-dimethyltetracyclo-3-dodecene. The α-olefin is as described above.

Examples of commercially available products of the cyclic olefin-based resin described above include APEL (manufactured by Mitsui Chemicals, Inc.), TOPAS COC (manufactured by Polyplastics Co., Ltd.), ZEONOR (manufactured by Zeon Corporation), and the like.

The cyclic olefin-based resin preferably has a number average molecular weight, which is measured by a gel permeation chromatography (GPC) method, of 1000 or more and 1 million or less. When the number average molecular weight falls within the above-described range, film formation is facilitated.

The cyclic olefin-based resin has a melt volume rate (MVR) at 230° C. of preferably 2 cm³/10 min or more and 15 cm³/10 min or less, more preferably 3 cm³/10 min or more and 14 cm³/10 min or less, and much more preferably 4 cm³/10 min or more and 13 cm³/10 min or less.

The cyclic olefin-based resin has a glass transition temperature of preferably 20° C. or higher and 130° C. or lower, and more preferably 50° C. or higher and 100° C. or lower. When the glass transition temperature is 20° C. or higher, the heat-shrinkable film can exhibit favorable heat resistance, and natural shrinkage can be suppressed. On the other hand, when the glass transition temperature is 130° C. or lower, the heat shrinkage rate of the heat-shrinkable film in the main shrinkage direction thereof can be sufficiently increased. In a case where the cyclic olefin-based resin is a resin mixture containing two or more types of cyclic olefin-based resins having different glass transition temperatures, the glass transition temperature means an apparent glass transition temperature calculated by summing the products of the glass transition temperatures and blending proportions (ratios by weight) of the respective cyclic olefin-based resins.

The cyclic olefin-based resin has a density of preferably 1.00 g/m³ or more and 1.05 g/m³ or less, and more preferably 1.01 g/m³ or more and 1.04 g/m³ or less.

When the total of the thermoplastic resin contained in the core layer 1 is 100% by weight, the core layer 1 contains the cyclic olefin-based resin in an amount of preferably 0.1% by weight or more and 85% by weight or less, more preferably 1% by weight or more and 80% by weight or less, and much more preferably 5% by weight or more and 75% by weight or less.

### [Ethylene-Based Resin]

The ethylene-based resin is a resin containing an ethylene component in amount of 50 mol % or more. The ethylene-based resin improves the shock strength of the heat-shrinkable film 10, and in a case where the ethylene-based resin is used for an outer layer such as the surface layer 2, improves the sebum whitening resistance of the heat-shrinkable film 10. Examples of the ethylene-based resin include branched low-density polyethylene, linear low-density polyethylene, an ethylene-vinyl acetate copolymer, an ionomer resin, and a mixture thereof. Further, the examples include an ethylene-based copolymer containing ethylene as a main component and α-olefin as a copolymerization component. The above-described copolymer may be a random copolymer or a block copolymer. Examples of the α-olefin may include α-olefin with a carbon number of 3 to 20, and specific examples thereof include propylene, 1-butene, 3-methyl-1-butene, 3-methyl-1-pentene, 4-methyl-1-pentene, 1-pentene, 1-hexene, 1-heptene, 1-octene, 1-decene, 1-tetradecene, 1-hexadecene, 1-octadecene, 1-eicosene, and the like. The ratio of the α-olefin as the copolymerization component is preferably 1 to 25 mol %. The ethylene-based resin may be a mixture of different ethylene-α-olefin random copolymers. The ethylene-based resin may further contain an ethylene-based elastomer.

The ethylene-based resin has a density of preferably 0.88 g/cm³ or more and 0.95 g/cm³ or less.

The ethylene-based resin has a melting point of preferably 70° C. or higher, more preferably 75° C. or higher, and much more preferably 80° C. or higher. When the melting point of the ethylene-based resin is the above-described lower limit or higher, the natural shrinkage rate of the heat-shrinkable film 10 can be suppressed. Moreover, the ethylene-based resin has a Vicat softening temperature of preferably 80° C. or higher, more preferably 85° C. or higher, and much more preferably 90° C. or higher. In a case where the ethylene-based resin is a resin mixture containing two or more types of ethylene-based resins having different melting points, the melting point means the highest one of the melting points of the ethylene-based resins.

The ethylene-based resin has a melt flow rate (MFR) at 190° C. of preferably 0.5 g/10 min or more and 5 g/10 min or less, more preferably 0.7 g/10 min or more and 3 g/10 min or less, and much more preferably 0.9 g/10 min or more and 2 g/10 min or less.

When the total of the thermoplastic resin contained in the core layer 1 is 100% by weight, the core layer 1 contains the ethylene-based resin in an amount of preferably 0.1% by weight or more and 65% by weight or less, more preferably 1% by weight or more and 60% by weight or less, and much more preferably 2% by weight or more and 55% by weight or less.

### [Microparticle]

The core layer 1 may further contain microparticles 3 in addition to the thermoplastic resin. The microparticles 3 may be derived from a recycled raw material, or may be newly added upon formation of the core layer 1. Examples of the recycled raw material include a heat-shrinkable film containing the thermoplastic resin as a main component and further containing the microparticles 3 as an antiblocking agent.

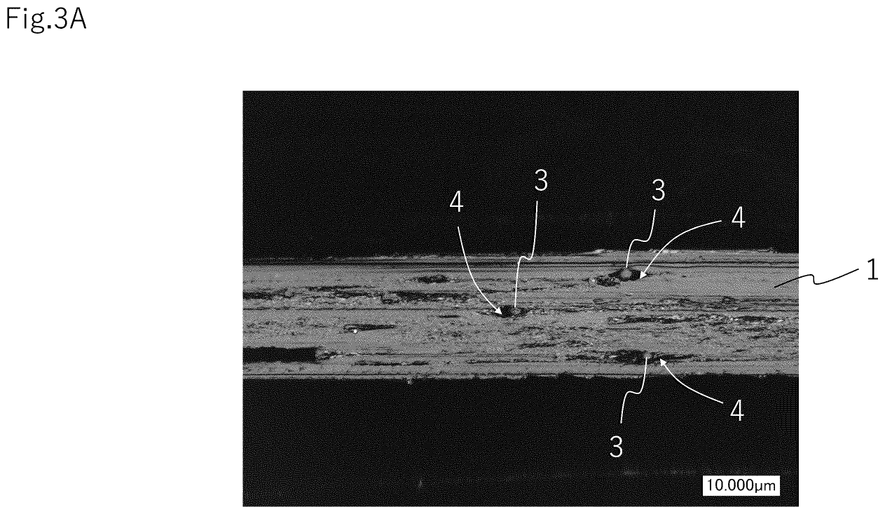

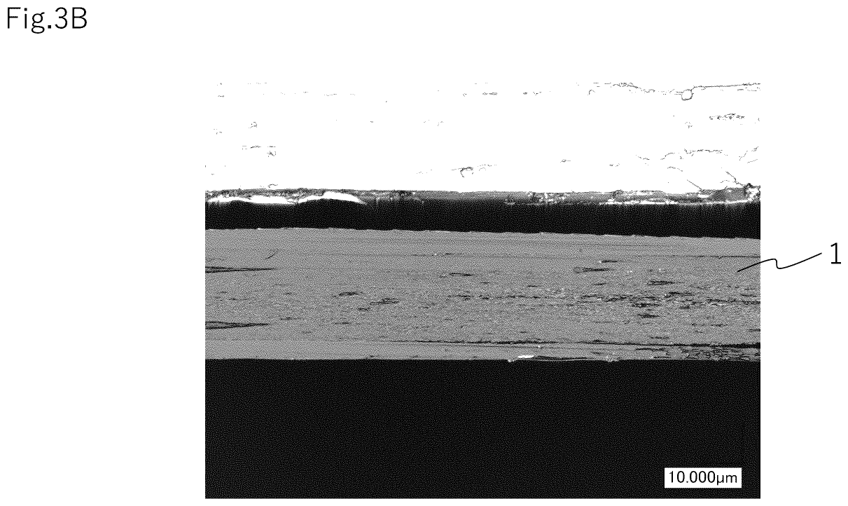

FIG. 3A is a microphotograph of the section of the core layer 1 (center portion in an up-down direction) containing the microparticles 3, and FIG. 3B is a microphotograph of the section of the core layer 1 (center portion in an up-down direction) containing no microparticles 3. The core layer 1 shown in FIG. 3A is blended with the microparticles 3 in an amount of 2 parts by weight for the sake of further clarification of the behavior of the microparticles 3 and the thermoplastic resin. As can be seen from comparison between FIGS. 3A and 3B, in a case where the core layer 1 is stretched with containing the microparticles 3 described above, closed pores 4 surrounding the respective microparticles 3 are formed in the core layer 1 as shown in FIG. 3A. The diameter of the microparticle 3 of FIG. 3A is 3 to 6 μm, and the size of the closed pore 4 is about 6 μm in the thickness direction (up-down direction in the figure) of the core layer 1, and is about 10 μm in a planar direction (right-left direction in the figure).

A space formed around the microparticle 3 by the closed pore 4 further decreases the density of the core layer 1, and facilitates gravity separation upon recycling of the heat-shrinkable film 10. As described above, the heat-shrinkable film 10 may be configured such that not only the heat-shrinkable film 10 contains the recycled raw material, but also recycling of the heat-shrinkable film 10 itself is facilitated.

As the microparticle 3, any of an organic microparticle or an inorganic microparticle may be used. As the organic microparticle, an organic microparticle such as an acrylic-based resin microparticle, a styrene-based resin microparticle, a styrene-acrylic-based resin microparticle, a urethane-based resin microparticle, or a silicone-based resin microparticle may be used. These microparticles may or may not be cross-linked, but are preferably cross-linked for enhancing the heat resistance of the microparticles. Of these microparticles, the acrylic-based resin microparticle is preferable from the viewpoint of compatibility with the cyclic olefin-based resin, and a polymethylmethacrylate-based cross-linked microparticle is more preferable. Examples of commercially available products of the organic microparticle described above include TECHPOLYMER (manufactured by Sekisui Kasei Co., Ltd.), Fine Sphere (manufactured by Nippon Paint Co., Ltd.), GANZPEARL (manufactured by Aica Kogyo Company, Limited), and ART PEARL (manufactured by Negami Chemical Industrial Co., Ltd.).

As the inorganic microparticle, for example, silica, zeolite, alumina, or the like may be used. The microparticle may be formed as a hollow glass balloon, or may be formed of a porous body.

The microparticles 3 have, for example, a most frequent particle size of preferably 1 μm or more and 8 μm or less, more preferably 2 μm or more and 7 μm or less, and much more preferably 3 μm or more and 6 μm or less. The most frequent particle size can be measured by a well-known laser diffraction scattering method or the like. When the most frequent particle size of the microparticles 3 falls within the above-described range, agglomeration is suppressed, and accordingly, the haze value of the heat-shrinkable film 10 is less likely to increase and smoothness is maintained. Note that from the viewpoint of reliably forming the closed pores 4, the most frequent particle size of the microparticles 3 is preferably sufficiently small with respect to the thickness of the core layer 1. The microparticles 3 may include two or more types of microparticles having different most frequent particle sizes.

When the total of the thermoplastic resin contained in the core layer 1 is 100 parts by weight, the core layer 1 contains the microparticles in an amount of preferably 0.005 parts by weight or more and 1 part by weight or less, more preferably 0.01 parts by weight or more and 1 part by weight or less, and much more preferably 0.03 parts by weight or more and 0.8 parts by weight or less. When the content of the microparticles 3 is the above-described lower limit or more, the closed pores 4 can be formed to such an extent that the density of the heat-shrinkable film 10 is sufficiently decreased. On the other hand, when the content of the microparticles 3 is the above-described upper limit or less, a probability of light being scattered by the closed pores 4 and the haze of the heat-shrinkable film 10 being excessively increased can be avoided.

### 1-2. Second Example of Core Layer

In a case where the core layer 1 contains the microparticles 3, the core layer 1 can be formed not according to the first example but according to a second example described below. The core layer 1 according to the second example contains at least a propylene-based resin; at least one of a petroleum resin, a terpene-based resin, or a rosin-based resin; a cyclic olefin-based resin; an ethylene-based resin; and microparticles. Hereinafter, points different from the first example will be mainly described.

### [Propylene-Based Resin]

Specific examples of the propylene-based resin have been described in the first example, but in the second example, the Vicat softening temperature of the propylene-based resin is preferably 60° C. or higher, more preferably 90° C. or higher, and much more preferably 100° C. or higher. In a case where the propylene-based resin is a resin mixture containing two or more types of propylene-based resins having different Vicat softening temperatures, the Vicat softening temperature of the propylene-based resin means an apparent Vicat softening temperature calculated by summing the products of the Vicat softening temperatures and blending proportions (ratios by weight) of the respective propylene-based resins.

The propylene-based resin has an MFR at 230° C. of preferably 1.0 g/10 min or more and 12.0 g/10 min or less, more preferably 2.0 g/10 min or more and 10.0 g/10 min or less, and much more preferably 2.5 g/10 min or more and 8.0 g/10 min or less.

The propylene-based resin has a density of preferably 0.86 g/cm³ or more and 0.93 g/cm³ or less.

When the total of the thermoplastic resin contained in the core layer 1 is 100% by weight, the core layer 1 according to the second example contains the propylene-based resin in an amount of preferably 10% by weight or more and 75% by weight or less, more preferably 15% by weight or more and 50% by weight or less, and much more preferably 20% by weight or more and 45% by weight or less.

### [Hydrocarbon Resin]

A hydrocarbon resin, i.e., the petroleum resin, the terpene-based resin, and the rosin-based resin, is as described in the first example, and therefore, description thereof will be omitted.

### [Cyclic Olefin-Based Resin]

The cyclic olefin-based resin is as described in the first example, and therefore, description thereof will be omitted.

### [Ethylene-Based Resin]

Specific examples, preferable density range, and preferable content range of the ethylene-based resin are as described in the first example. In the second example, the ethylene-based resin has a melting point of preferably 50° C. or higher, more preferably 60° C. or higher, and much more preferably 75° C. or higher. When the melting point of the ethylene-based resin is the above-described lower limit or higher, the natural shrinkage rate of a heat-shrinkable film 10 can be suppressed. Moreover, the ethylene-based resin has a Vicat softening temperature of preferably 45° C. or higher, more preferably 50° C. or higher, and much more preferably 52.5° C. or higher.

The ethylene-based resin has an MFR at 190° C. of preferably 0.5 g/10 min or more and 10 g/10 min or less, more preferably 0.7 g/10 min or more and 8 g/10 min or less, and much more preferably 0.9 g/10 min or more and 7 g/10 min or less.

### [Microparticle]

Specific examples and preferable most frequent particle size range of the microparticles 3 are as described in the first example. In the second example, when the total of the thermoplastic resin contained in the core layer 1 is 100 parts by weight, the core layer 1 contains the microparticles in an amount of preferably 0.005 parts by weight or more and 3 parts by weight or less, more preferably 0.01 parts by weight or more and 2 parts by weight or less, and much more preferably 0.03 parts by weight or more and 1 part by weight or less. When the content of the microparticles 3 is the above-described lower limit or more, closed pores 4 can be formed to such an extent that the density of the heat-shrinkable film 10 is sufficiently decreased. On the other hand, when the content of the microparticles 3 is the above-described upper limit or less, a probability of light being scattered by the closed pores 4 and the haze of the heat-shrinkable film 10 being excessively increased can be avoided.

### <1-3. Thickness of Core Layer>

Each of the core layers 1 according to the first and second examples has a thickness of preferably 10 μm or more and 80 μm or less, more preferably 15 μm or more and 70 μm or less, and much more preferably 20 μm or more and 60 μm or less. Note that in description below, in a case applicable to any of the core layers 1 according to the first and second examples, these core layers 1 will be merely collectively referred to as a “core layer 1” without particularly distinguished from each other.

### <2. Surface Layer>

The surface layer 2 contains a thermoplastic resin as a main component. Examples of the thermoplastic resin include a styrene-based resin, an ester-based resin, an olefin-based resin, and the like. Of these resins, the olefin-based resin is preferable. In addition, the surface layer 2 may further contain microparticles as an antiblocking agent. Main olefin-based resins such as an ethylene-based resin, a propylene-based resin, a petroleum resin, a terpene-based resin, a rosin-based resin, and a cyclic olefin-based resin and the microparticles are as already described above.

Preferably, the surface layer 2 contains at least one of the petroleum resin, the terpene-based resin, or the rosin-based resin, the cyclic olefin-based resin, the ethylene-based resin, and the microparticles. With this configuration, the heat-shrinkable film 10 including the core layer 1 and the surface layer 2 is easily used as the recycled raw material of the heat-shrinkable film 10. Note that these olefin-based resins and microparticles may be the same as those of the core layer 1 in a composition or the like or be different from those of the core layer 1 in a composition or the like. In a case where the core layer 1 and the surface layer 2 are adjacent to each other and both contain the cyclic olefin-based resin, coupling strength between the layers is improved. In a case where the surface layer 2 contains the ethylene-based resin, the sebum whitening resistance is improved.

When the total of the thermoplastic resin contained in the surface layer 2 is 100% by weight, the surface layer 2 contains, but not limited to, the hydrocarbon resin (petroleum resin, terpene-based resin, and rosin-based resin) in an amount of preferably 0.1% by weight or more and 25% by weight or less, more preferably 1% by weight or more and 20% by weight or less, and much more preferably 5% by weight or more and 15% by weight or less. Similarly, the surface layer 2 contains the cyclic olefin-based resin in an amount of preferably 65% by weight or more and 95% by weight or less, more preferably 70% by weight or more and 90% by weight or less, and much more preferably 75% by weight or more and 85% by weight or less. Moreover, the surface layer 2 contains the ethylene-based resin in an amount of preferably 0.1% by weight or more and 30% by weight or less, more preferably 1% by weight or more and 25% by weight or less, and much more preferably 5% by weight or more and 20% by weight or less.

When the total of the thermoplastic resin contained in the surface layer 2 is 100 parts by weight, the surface layer 2 contains the microparticles in an amount of preferably 0.01 parts by weight or more and 1 part by weight or less, more preferably 0.03 parts by weight or more and 0.8 parts by weight or less, and much more preferably 0.05 parts by weight or more and 0.5 parts by weight or less.

### [Thickness of Surface Layer]

The surface layer 2 has a thickness of preferably 1 μm or more and 25 μm or less, more preferably 2.5 μm or more and 20 μm or less, and much more preferably 5 μm or more and 15 μm or less. When the thickness of the surface layer 2 is 1, the core layer 1 has a thickness of preferably 4 or more and 8 or less, and more preferably 5 or more and 7 or less.

### <3. Other Components>

In addition, additives such as an antioxidant, a heat stabilizer, an ultraviolet absorber, a light stabilizer, a lubricant, an antistatic agent, a flame retardant, an antibacterial agent, a fluorescent brightener, and a colorant may be added to at least one of the core layer 1 or the surface layer 2 as necessary.

### <4. Thickness of Heat-Shrinkable Film>

The heat-shrinkable film 10 has, for example, a total thickness of preferably 10 μm or more and 80 μm or less, more preferably 15 μm or more and 70 μm or less, and much more preferably 20 μm or more and 60 μm or less. When the total thickness of the heat-shrinkable film 10 falls within the above-described range, excellent heat-shrinkable properties can be exhibited, favorable shape followability can be exhibited in a case where the heat-shrinkable film 10 is attached to a container, and the heat-shrinkable film 10 can be suitably used as a base film of a heat-shrinkable label.

### <5. Heat Shrinkage Performance of Heat-Shrinkable Film>

The heat-shrinkable film 10 preferably has a heat shrinkage rate in the main shrinkage direction of 55% or more when the heat-shrinkable film 10 is immersed in hot water at 90° C. for 10 seconds. Moreover, the heat-shrinkable film 10 preferably has a heat shrinkage rate in the main shrinkage direction of 65% or more when the heat-shrinkable film 10 is immersed in hot water at 98° C. for 10 seconds. When the heat shrinkage rate is the above-described upper limit or more, the heat-shrinkable film 10 can be suitably used as a heat-shrinkable film without any problems such as poor shrinkage.

### <6. Natural Shrinkage Rate of Heat-Shrinkable Film>

The heat-shrinkable film 10 preferably has a natural shrinkage rate in the main shrinkage direction of 2% or less when the heat-shrinkable film 10 stands in a thermostatic chamber set at 40° C. for 7 days, and preferably has a natural shrinkage rate in a direction (also referred to as a “sub-shrinkage direction”) perpendicular to the main shrinkage direction of 0.3% or less.

### <7. Method for Producing Heat-Shrinkable Film>

A method for producing the heat-shrinkable film 10 is not particularly limited, but is preferably a method of simultaneously forming layers by a co-extrusion method in a case where the heat-shrinkable film 10 has a multilayer structure. In a case where the co-extrusion method is co-extrusion with a T-die, a lamination method may be any of a feed block method, a multi-manifold method, or a combination thereof.

Specifically, for example, the method for producing the heat-shrinkable film 10 includes a method in which raw materials for the core layer 1 and the surface layer 2 are injected into an extruder, extruded into a sheet shape by a die, cooled and solidified by a take-off roll, and then stretched uniaxially or biaxially, preferably biaxially. As the above-described stretching method, for example, a roll stretching method, a tenter stretching method, or a combination thereof may be used. A stretching temperature is changed according to the softening temperatures of the resins forming the film, shrinkage properties required for the heat-shrinkable film 10, and the like, but is preferably 140° C. or lower, and more preferably 120° C. or lower.

A stretching ratio in the main shrinkage direction is changed according to the resins forming the film, stretching means, the stretching temperature, and the like, but is preferably 3 times or more and 7 times or less, and more preferably 4 times or more and 6 times or less. Moreover, a stretching ratio in the sub-shrinkage direction is preferably 1.1 times or more and 1.5 times or less, and more preferably 1.2 times or more and 1.4 times or less.

In a case where the core layer 1 contains the microparticles 3, the above-described stretching temperature and stretching ratios allow efficient formation of the closed pores around the microparticles and allow easy control of the density of the heat-shrinkable film 10.

### <8. Use Application of Heat-Shrinkable Film>

Use application of the heat-shrinkable film 10 is not particularly limited, but for example, is suitably used as a base film of a heat-shrinkable label attached to a container such as a plastic bottle or a metal can. In this case, for example, a label design print layer is stacked on at least one side of the heat-shrinkable film 10. Then, the heat-shrinkable film 10 is cut into a predetermined size, and a center seal is provided therefor. In this manner, a tubular heat-shrinkable label is formed.

### <9. Other Aspects of Heat-Shrinkable Film>

In the description above, the heat-shrinkable film 10 has the single-layer configuration including only the core layer 1 or the double-layer or triple-layer configuration including the surface layer 2 stacked on at least one of the first or second surface of the core layer 1. However, the heat-shrinkable film 10 is not limited to these configurations, and may further include a layer stacked on the surface layer 2 or a layer stacked between the core layer 1 and the surface layer 2. That is, the heat-shrinkable film 10 may have a four-layer or five-layer configuration.

### <10. Characteristics>

Since the heat-shrinkable film 10 includes the core layer 1 containing the propylene-based resin, the hydrocarbon resin, the cyclic olefin-based resin, and the ethylene-based resin having a relatively-high melting point, high heat-shrinkable properties in hot water at 90° C. or higher are exhibited while the natural shrinkage is suppressed. Thus, in a case where the heat-shrinkable film 10 is formed as the tubular heat-shrinkable label, the heat-shrinkable film 10 can easily follow the shape of the container to which the heat-shrinkable film 10 is attached, a gap between the heat-shrinkable film 10 and the container can be reduced, and favorable attachability can be achieved. It is less likely to cause a trouble that the container cannot be covered with the heat-shrinkable label because of a decrease in the diameter of the tubular heat-shrinkable label due to the natural shrinkage. Further, since the natural shrinkage is suppressed also in the sub-shrinkage direction, the area of the heat-shrinkable label cut out from the heat-shrinkable film 10 can be minimized, and a yield can be improved. As described above, the heat-shrinkable label including the heat-shrinkable film 10 also falls within the scope of the present invention.

The core layer 1 can contain the recycled raw material derived from the resin film containing the propylene-based resin, the hydrocarbon resin, the cyclic olefin-based resin, or the ethylene-based resin. The cyclic olefin-based resin improves the heat shrinkage rate and the rigidity, and the ethylene-based resin improves the shock strength. The core layer 1 can further contain the microparticles 3. With the microparticles 3, the closed pores are formed in the core layer 1 having a thickness sufficiently greater than the diameter of the microparticles 3, and accordingly, the density of the heat-shrinkable film 10 is easily set to less than 1 g/cm³, preferably 0.95 g/cm³ or less. Thus, the heat-shrinkable film 10 can be provided, which is easily separated from a styrene-based resin film or an ester-based resin film having a density of more than 1 g/cm³ and is easily recycled. The heat-shrinkable film 10 may further contain an environmental load reducing material other than the recycled raw material derived from the above-described resin film, and all the resin components may be substantially made of environmental load reducing materials.

Examples of the environmental load reducing material include a material derived from biomass and a material obtained by chemically recycling the resin film including the heat-shrinkable film 10 and a production intermediate material thereof. The examples further include mechanically-recycled materials such as fluff obtained by crushing the resin film including the heat-shrinkable film 10 and the production intermediate material thereof and having only a heat history upon film production and recycled pellets to which a heat history is added again. Examples of the production intermediate material include a resin film downgraded in a printing process and subjected to a deinking process, scraps of a resin film, slit waste, a resin composition caused upon extrusion without molded as a resin film, and the like. The usage of the environmental load reducing material may be assigned to the heat-shrinkable film 10 according to a mass balance method.

### WORKING EXAMPLES

Hereinafter, working examples of the present invention will be described in detail. Note that the present invention is not limited to these working examples.

### 1. Preparation of Working Examples and Comparative Example

As described later, heat-shrinkable films according to Working Examples 1 to 12 and a comparative example were prepared. As shown in FIG. 2, each of these heat-shrinkable films had a triple-layer structure including a core layer and surface layers stacked on both surfaces of the core layer. Materials used for the core layer and the surface layer are as follows:
(1) propylene-based resin (PP): having a density of 0.9 g/cm³ based on JIS K7112, an MFR at 230° C. of 5.5 g/10 min, a Vicat softening temperature of 111° C. based on ISO 306, and a melting point of 132° C. based on ISO 11357-3;
(2) cyclic olefin-based resin (COC): having a density of 1.01 g/cm³ based on JIS K7112, an MVR at 230° C. of 12 cm³/10 min, and a glass transition temperature of 78° C. based on ISO 11357-1, 2, and 3;
(3) petroleum resin: having a density of 0.98 g/cm³ based on JIS K7112, and a softening point of 125° C. based on JIS K6863 (ring-and-ball method);
(4) ethylene-based resin: containing a copolymer of ethylene and 1-hexene, which contains an ethylene component in an amount of 50 mol % or more, and having a density of 0.915 g/cm³ based on JIS K7112, an MFR at 190° C. of 1.0 g/10 min based on JIS K7210, a Vicat softening temperature of 98° C. based on JIS K7206, and a melting point of 118° C. based on JIS K7121; and
(5) microparticles: made of cross-linked polymethylmethacrylate (PMMA) resin, and having a most frequent particle size of 4 μm based on particle size distribution measured using a laser diffraction particle size distribution measurement device (LA-500 manufactured by HORIBA, Ltd.).

These materials were blended in the proportions shown in Table 1, and in this manner, raw material compositions for the core layer and the surface layer according to Working Examples 1 to 12 and the comparative example were obtained.

Subsequently, the raw material compositions forming the core layer and the surface layer were melted at a barrel temperature of 200° C. for the core layer and at a barrel temperature of 220° C. for the surface layer, and were extruded from a T-die by an extruding machine. Then, the resultant was cooled and solidified with a roll cooled to 30° C., and in this manner, an unstretched sheet was prepared. The unstretched sheet was stretched 6 times in a transverse direction (TD) and 1.2 times in a machine direction (MD) with a tenter stretching machine at a temperature of 120° C. to prepare a heat-shrinkable film having a thickness proportion shown in Table 1. Hereinafter, the main shrinkage direction of the heat-shrinkable film will also be referred to as a transverse direction, and the sub-shrinkage direction will also be referred to as an machine direction.

TABLE 1

| | | | Working Examples | | | | | | | | | | | | Comparative |
|---|---|---|---|---|---|---|---|---|---|---|---|---|---|---|---|
| | | Blending Amount | 1 | 2 | 3 | 4 | 5 | 6 | 7 | 8 | 9 | 10 | 11 | 12 | Example |
| Surface | COC | % by weight | 80 | 80 | 80 | 80 | 80 | 80 | 80 | 80 | 80 | 80 | 80 | 80 | 80 |
| Layer | PE | % by weight | 10 | 10 | 10 | 10 | 10 | 10 | 10 | 10 | 10 | 10 | 10 | 10 | 10 |
| | Petroleum Resin | % by weight | 10 | 10 | 10 | 10 | 10 | 10 | 10 | 10 | 10 | 10 | 10 | 10 | 10 |
| | Microparticles | part(s) by weight | 0.1 | 0.1 | 0.1 | 0.1 | 0.1 | 0.1 | 0.1 | 0.1 | 0.1 | 0.1 | 0.1 | 0.1 | 0.1 |
| Core | PP | % by weight | 45 | 35 | 25 | 45.5 | 45.5 | 45.5 | 45.5 | 60 | 45.5 | 45.5 | 44.2 | 60 | 75 |
| Layer | Petroleum Resin | % by weight | 25 | 25 | 25 | 22.7 | 22.7 | 32.7 | 23.7 | 30 | 22.7 | 22.7 | 22.1 | 30 | 25 |
| | COC | % by weight | 20 | 20 | 20 | 18.2 | 18.2 | 18.2 | 18.2 | 5 | 18.2 | 18.2 | 30 | 5 | — |
| | PE | % by weight | 10 | 20 | 30 | 13.6 | 13.6 | 13.6 | 13.6 | 5 | 13.6 | 13.6 | 3.7 | 5 | — |
| | Microparticles | part(s) by weight | — | — | — | 0.03 | 0.06 | 0.5 | 1 | 0.01 | 2 | — | — | — | — |

| | | | | | | | | | | | | | |
|---|---|---|---|---|---|---|---|---|---|---|---|---|---|
| Layer Ratio | 1/6/1 | 1/6/1 | 1/6/1 | 1/6/1 | 1/6/1 | 1/6/1 | 1/6/1 | 1/6/1 | 1/6/1 | 1/6/1 | 1/6/1 | 1/6/1 | 1/6/1 |

### 2. Evaluation

The heat-shrinkable films according to Working Examples 1 to 12 and the comparative example were evaluated as follows.

### <2-1. Heat Shrinkage Rate>

The same number of samples each having a size of 100 mm in the machine direction×100 mm in the transverse direction was cut out from each heat-shrinkable film. Each sample was immersed in hot water at a temperature described below for 5 seconds or 10 seconds, taken out and immersed in water at 20° C. for 10 seconds, and taken out again. Thereafter, the length L1 (mm) of each sample in the machine direction and the length L2 (mm) of each sample in the transverse direction were measured, and a shrinkage rate (%) in each of the machine direction and the transverse direction was calculated according to the following formula. For each heat-shrinkable film, the average of the shrinkage rates of the samples was taken as a heat shrinkage rate.

$$Shrinkage Rate ( \% ) = \{ ( 100 - L ) / 100 \} \times 100 ( L = L 1 , L 2 )$$

Water at 70° C., 80° C., 90° C., and 98° C. was used as the hot water, and five above-described samples were prepared for each heat-shrinkable film. Separately for the case of the immersion for 5 seconds and the case of the immersion for 10 seconds, the heat shrinkage rate in each of the machine direction and the transverse direction was calculated. The heat shrinkage rate in the transverse direction was evaluated as follows:
(1) immersion in hot water at 90° C. for 10 seconds: 55% or more as favorable, and less than 55% as unfavorable; and
(2) immersion in hot water at 98° C. for 10 seconds: 65% or more as favorable, and less than 65% as unfavorable.

### <2-2. Natural Shrinkage Rate>

The same number of samples each having a size of 100 mm in the machine direction×100 mm in the transverse direction was cut out from each heat-shrinkable film. Each sample stood in a thermostatic chamber (IL-82 manufactured by Yamato Scientific Co., Ltd.) set at 30° C. or 40° C. for 7 days, and thereafter, the length L1 (mm) of each sample in the machine direction and the length L2 (mm) of each sample in the transverse direction were measured and a shrinkage rate (%) was calculated according to a formula similar to that for the heat shrinkage rate. For each heat-shrinkable film, the average of the shrinkage rates of the samples was taken as a natural shrinkage rate. Two samples were prepared for each temperature.

The natural shrinkage rate at 40° C. was evaluated as follows:
(1) transverse direction: 2% or less as favorable, and more than 2% as unfavorable; and
(2) machine direction: 0.3% or less as favorable, and more than 0.3 as unfavorable.

### <2-3. Young's Modulus>

From each of the heat-shrinkable films according to Working Examples 1 to 3 and the comparative example, five samples each having 250 mm in the machine direction×5 mm in the transverse direction and five samples each having 250 mm in the transverse direction×5 mm in the machine direction were cut out. For these samples, Young's moduli (GPa) in the machine direction and the transverse direction were measured using a Strograph (VE-1D manufactured by Toyo Seiki Seisaku-sho, Ltd.) by a method according to ASTM D882. For each heat-shrinkable film, the average of the Young's moduli of the samples in each direction was taken as a Young's modulus in each direction.

The Young's modulus was evaluated as follows:
(1) 1.6 GPa or more in the machine direction and 2.2 GPa or more in the transverse direction: favorable; and
(2) the above-described conditions are not satisfied: unfavorable.

### <2-4. Shrinkage Stress>

From each heat-shrinkable film, samples each having 10 mm in the machine direction×200 mm in the transverse direction were cut out. One end portion of each sample in the transverse direction was fixed with an inter-chuck distance of 100 mm, and the other end portion was connected to a load cell for measuring a load. Thereafter, the sample was immersed, together with a chuck, in hot water at 80° C. for 30 seconds, and heat-shrank accordingly. Then, shrinkage stresses (N/10 mm) at an initial stage of the immersion and after a lapse of 30 seconds were measured. For each heat-shrinkable film, the average of the shrinkage stresses of the samples was taken as a shrinkage stress.

### <2-5. Haze>

From each heat-shrinkable film, four samples each having 50 mm×100 mm were cut out. By a method according to JIS K-7136, the haze (%) of each sample was measured using a haze meter (NDH5000 manufactured by Nippon Denshoku Industries Co., Ltd.). For each heat-shrinkable film, the average of the hazes of the samples was taken as a haze.

### <2-6. Density>

From each of the heat-shrinkable films according to Working Examples 4 to 12, four samples each having 50 mm×100 mm were cut out. For these samples, a density (g/cm³) was measured using a dry automatic density meter (1345-100CC manufactured by Shimadzu Corporation) by a method according to JIS Z8837 (2018). For each of the above-described heat-shrinkable films, the average of the densities of the samples was taken as a density.

### <3. Evaluation Results>

Evaluation results are shown in Table 2.

TABLE 2

| | | | Working Examples | | | | | | | | | | | | |
|---|---|---|---|---|---|---|---|---|---|---|---|---|---|---|---|
| | | | 1 | | 2 | | 3 | | 4 | | 5 | | 6 | | 7 |
| | | | Sample | | Sample | | Sample | | Sample | | Sample | | Sample | | Sample |
| | Measurement | | Direction | | Direction | | Direction | | Direction | | Direction | | Direction | | Direction |
| Items | Conditions | | MD | TD | MD | TD | MD | TD | MD | TD | MD | TD | MD | TD | MD |
| Young's | — | | 1.8 | 2.5 | 1.6 | 2.2 | 1.6 | 2.4 | — | — | — | — | — | — | — |
| Modulus | | | | | | | | | | | | | | | |
| Heat | 70° C. | 5 seconds | 0 | 1 | 0 | 1 | 0 | 1 | 0 | 0 | 0 | 0 | 0 | 0 | 0 |
| Shrinkage | | 10 seconds | 0 | 1 | 0 | 2 | 0 | 1 | 0 | 0.5 | 0 | 0.5 | 0 | 0.5 | 0 |
| | 80° C. | 5 seconds | 0 | 13 | −1 | 17 | 0 | 14 | −0.8 | 12.5 | 0 | 12.5 | 0 | 14 | 0 |
| | | 10 seconds | 0 | 19 | 0 | 22 | 0 | 20 | 0 | 19.5 | −1.3 | 19 | −1 | 19.5 | −0.5 |
| | 90° C. | 5 seconds | 4 | 53 | 3 | 54 | 4 | 53 | 1.3 | 54.8 | 3.5 | 54.8 | 2.5 | 54.5 | 2.8 |
| | | 10 seconds | 4 | 57 | 3 | 58 | 4 | 57 | 3 | 57 | 2.5 | 57.3 | 4 | 56.5 | 2.8 |
| | 95° C. | 5 seconds | 7 | 66 | 9 | 69 | 8 | 68 | 6 | 67 | 5 | 68 | 6 | 65 | 7 |
| | | 10 seconds | 8 | 68 | 9 | 70 | 8 | 69 | 11 | 68 | 10 | 69 | 11 | 70 | 10 |
| Natural | 30° C. | 1 week | 0.00 | 0.20 | 0.10 | 0.20 | 0.05 | 0.25 | 0.00 | 0.20 | 0.10 | 0.20 | 0.10 | 0.20 | 0.10 |
| Shrinkage | 40° C. | 1 week | 0.15 | 1.25 | 0.10 | 1.45 | 0.10 | 1.35 | 0.10 | 1.20 | 0.10 | 1.25 | 0.10 | 1.25 | 0.10 |
| Rate | | | | | | | | | | | | | | | |

| | | | | | | | | | |
|---|---|---|---|---|---|---|---|---|---|
| Shrinkage | 80° C. | Initial Stage | 2.2 | 2.9 | 2.4 | 2.2 | 2.3 | 2.5 | 2 |
| Stress | | After Lapse of | 2.0 | 2.5 | 2.2 | 2.2 | 2.3 | 2.5 | 2.2 |
| | | 30 seconds | | | | | | | |

| | | | | | | | | |
|---|---|---|---|---|---|---|---|---|
| Haze | — | 6.4 | 6.5 | 7.8 | 5.7 | 5.9 | 6.9 | 9.1 |
| Density | — | — | — | — | 0.950 | 0.949 | 0.944 | 0.938 |

| | | | Working Examples | | | | | | | | | | | | |
|---|---|---|---|---|---|---|---|---|---|---|---|---|---|---|---|
| | | | 7 | 8 | | 9 | | 10 | | 11 | | 12 | | Comparative | |
| | | | Sample | Sample | | Sample | | Sample | | Sample | | Sample | | Example | |
| | Measurement | | Direction | Direction | | Direction | | Direction | | Direction | | Direction | | Sample | |
| Items | Conditions | | TD | MD | TD | MD | TD | MD | TD | MD | TD | MD | TD | MD | TD |
| Young's | — | | — | — | — | — | — | — | — | — | — | — | — | 1.5 | 2.4 |
| Modulus | | | | | | | | | | | | | | | |
| Heat | 70° C. | 5 seconds | 0 | 0 | 0 | 0 | 0 | 0 | 0 | 0 | 0 | 0 | 0 | 0 | 2 |
| Shrinkage | | 10 seconds | 0.5 | 0 | 0.5 | 0 | 1 | 0 | 0.5 | 0 | 0.5 | 0 | 1 | 0 | 4 |
| | 80° C. | 5 seconds | 13.8 | 0 | 14 | 0 | 14.5 | −1 | 12.5 | 0 | 13 | 0 | 12.5 | 1 | 15 |
| | | 10 seconds | 20 | −0.5 | 19 | −0.3 | 20.5 | −0.5 | 20 | 0 | 19 | −0.5 | 19 | 1 | 21 |
| | 90° C. | 5 seconds | 55 | 2 | 54 | 2.5 | 54 | 2.3 | 54.8 | 2.7 | 55.5 | 2 | 53.5 | 3 | 49 |
| | | 10 seconds | 56 | 2.3 | 55 | 2.3 | 55 | 2.5 | 57 | 3 | 56 | 2.5 | 55 | 4 | 51 |
| | 95° C. | 5 seconds | 69 | 6 | 66 | 6 | 67 | 8 | 67 | 8 | 70 | 6 | 66 | 5 | 64 |
| | | 10 seconds | 69 | 11 | 67 | 8 | 69 | 13 | 70 | 8 | 72 | 8 | 68 | 6 | 64 |
| Natural | 30° C. | 1 week | 0.10 | 0.10 | 0.25 | 0.10 | 0.20 | 0.10 | 0.20 | 0.10 | 0.15 | 0.10 | 0.25 | 0.10 | 0.50 |
| Shrinkage | 40° C. | 1 week | 1.20 | 0.25 | 1.70 | 0.10 | 1.10 | 0.10 | 1.00 | 0.10 | 1.00 | 0.25 | 1.65 | 0.40 | 2.15 |
| Rate | | | | | | | | | | | | | | | |

| | | | | | | | | | |
|---|---|---|---|---|---|---|---|---|---|
| Shrinkage | 80° C. | Initial Stage | 2 | 2.3 | 2.0 | 2.2 | 2.2 | 2.2 | 2.4 |
| Stress | | After Lapse of | 2.2 | 2.4 | 2.0 | 2.1 | 2.3 | 2.4 | 2.1 |
| | | 30 seconds | | | | | | | |

| | | | | | | | | |
|---|---|---|---|---|---|---|---|---|
| Haze | — | 9.1 | 3.0 | 12 | 4.92 | 6.5 | 2.8 | 6.0 |
| Density | — | 0.938 | 0.945 | 0.926 | 0.953 | 0.960 | 0.946 | — |

| | |
|---|---|
| ZZZZZ | ZZZZZ |

The above-described results showed that any of Working Examples 1 to 12 exhibits sufficient quality in terms of the heat shrinkage rate and the natural shrinkage rate. On the other hand, in the comparative example where the core layer contains no cyclic olefin-based resin and ethylene-based resin, the heat shrinkage rates in hot water at 90° C. and hot water at 98° C. (for 10 seconds) and the natural shrinkage rate at 40° C. were evaluated as unfavorable. It was confirmed that the Young's modulus is evaluated as favorable in Working Examples 1 to 3 while the Young's modulus is evaluated as unfavorable in the comparative example. The results of Working Examples 4 to 12 showed that influence on the haze decreases as the proportion of the microparticles contained in the core layer decreases and the density decreases as the proportion increases. Particularly, it was confirmed that when the content of the microparticles in the core layer is 1 part by weight or less, the haze is maintained at 10% or less.

### REFERENCE SIGNS LIST

1 Core layer (first layer)
2 Surface layer (second layer)
3 Microparticle
4 Closed pore
10 Heat-shrinkable film

1. A heat-shrinkable film comprising:
a first layer containing at least one of a petroleum resin, a terpene-based resin, or a rosin-based resin and containing a propylene-based resin, a cyclic olefin-based resin, and an ethylene-based resin containing an ethylene component in an amount of 50 mol % or more and having a melting point of 70° C. or higher.

2. The heat-shrinkable film according to claim 1, wherein the first layer further contains a microparticle, and in the first layer, a closed pore is formed so as to surround the microparticle.

3. The heat-shrinkable film according to claim 1, further comprising:
a second layer stacked on at least one side of the first layer and containing a thermoplastic resin.

4. The heat-shrinkable film according to claim 1, wherein
when a total of a thermoplastic resin contained in the first layer is 100% by weight, the first layer contains the propylene-based resin in an amount of 10% by weight or more and 75% by weight or less, and
the propylene-based resin has a Vicat softening temperature of 90° C. or higher.

5. The heat-shrinkable film according to claim 4, wherein when the total of the thermoplastic resin contained in the first layer is 100% by weight, the first layer contains the propylene-based resin in an amount of 10% by weight or more and 50% by weight or less.

6. The heat-shrinkable film according to claim 1, wherein when a total of a thermoplastic resin contained in the first layer is 100% by weight, the first layer contains the ethylene-based resin in an amount of 0.1% by weight or more and 65% by weight or less.

7. The heat-shrinkable film according to claim 1, wherein the ethylene-based resin has a density of 0.88 g/cm³ or more and 0.95 g/cm³ or less.

8. The heat-shrinkable film according to claim 1, wherein the ethylene-based resin has a melting point of 75° C. or higher.

9. The heat-shrinkable film according to claim 1, wherein when a total of a thermoplastic resin contained in the first layer is 100% by weight, the first layer contains the cyclic olefin-based resin in an amount of 0.1% by weight or more and 85% by weight or less, and has a glass transition temperature of 20° C. or higher and 130° C. or lower.

10. The heat-shrinkable film according to claim 2, wherein when a total of a thermoplastic resin contained in the first layer is 100 parts by weight, the first layer contains the microparticles in an amount of 0.005 parts by weight or more and 1 part by weight or less.

11. The heat-shrinkable film according to claim 2, wherein the microparticles have a most frequent particle size of 1 μm or more and 8 μm or less.

12. The heat-shrinkable film according to claim 1, wherein the heat-shrinkable film has a density of 0.95 g/cm³ or less.

13. The heat-shrinkable film according to claim 1, wherein the heat-shrinkable film has a haze of 10% or less.

14. The heat-shrinkable film according to claim 3, wherein the second layer contains at least one of a petroleum resin, a terpene-based resin, or a rosin-based resin and containing a cyclic olefin-based resin, an ethylene-based resin, and a microparticle.

15. The heat-shrinkable film according to claim 3, wherein when a thickness of the second layer is 1, the first layer has a thickness of 4 or more and 8 or less.

16. A heat-shrinkable label comprising:
the heat-shrinkable film according to claim 1.
